(19) United States
(12) Patent Application Publication
(10) Pub. No.: US 2007/0011169 A1
(43) Pub. Date: Jan. 11, 2007

(54) Method and system for collecting data from diverse sources and transforming the collected data into a user-friendly format

(75) Inventor: Michael A. Parisi, Fairport, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/174,701

(22) Filed: Jul. 5, 2005

(51) Int. Cl. G06F 17/30

(52) U.S. Cl. 707/10

(57) ABSTRACT

A method utilizes a computer-based system, for processing data gathered from diverse sources and diverse formats by establishing an object. The method determines the format of a data source; determines a communication protocol to retrieve data from the data source; uses the object, using the determined format and communication protocol, to retrieve data from the data source, the object acquiring information and transforming the information into a consistent format; receives input from a user; instantiates, in accordance with the input from the user, the object; and conveys data generated by the object to the user. The data generated by the object may be displayed, reproduced, or manipulated on a user readable medium. Moreover, the data generated by the object may be displayable in a spreadsheet format. The method generates a wrapper function to invoke the object, the wrapper function including parameters that, when entered by a user, invoke the action of the component or object.

### BACKGROUND

Users face the challenge of a continuing need for actionable information, while controlling the cost obtaining and using that information. Also, users face the challenge that the needed information may be in diverse forms and may be located in various places. This data may provide a basis for making decisions, research information classification, information correlations and/or comparisons, etc.

Computers are conventionally used as a tool for collecting information and then transforming it into an actionable form. One example of an actionable form is a form that enables a user of information to understand and analyze the information in order to determine a prudent course of action. Other examples may include a form that enables a user of information to understand and analyze the information for research purposes and/or to determine relationships there between.

Conventionally, actionable information may be presented in the form of a computer-readable data structure such as an electronic spreadsheet or any other computer-readable data structure that is sufficiently understandable so as to be properly analyzed. Yet the task of gathering that information from diverse sources and transforming the collected data into an appropriate computer-readable data structure can be a costly and inefficient process.

An example of this problem may be the case of a user searching the Internet for information. Conventional Internet searches may have unacceptably low success rates in gathering data, inconvenient, and/or obscure presentation, thereby making evaluations of the results time consuming, difficult, and/or impossible.

It is noted that the information to be gathered may be in places other than the Internet. It is also noted that the information to be gathered may not be in a computer-readable format.

Therefore, it is desirable to provide a system and method for gathering information from diverse sources and diverse formats and for transforming that information into a user-friendly format to facilitate understanding and/or analysis.

### BRIEF DESCRIPTION OF THE DRAWING

The drawings are only for purposes of illustrating various embodiments and are not to be construed as limiting, wherein:

FIG. 1 is a block diagram illustrating the gathering of data from diverse sources;

FIG. 2 is a flowchart illustrating a method of collecting data from diverse sources;

FIG. 3 graphically illustrates a method of transforming data into a user-friendly format;

FIG. 4 illustrates the use of an electronic spreadsheet as a user-friendly format;

FIG. 5 illustrates the use of a word processing application as a user-friendly format;

FIG. 6 is a flowchart illustrating the task of gathering intellectual property information from a web site;

FIG. 7 graphically illustrates the task of transforming intellectual property information into a user-friendly format;

FIG. 8 illustrates a conventional computer hardware configuration;

FIG. 9 illustrates the use of an component or object or object to parse a data source; and

FIG. 10 illustrates a method of integrating a component or object with host component.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

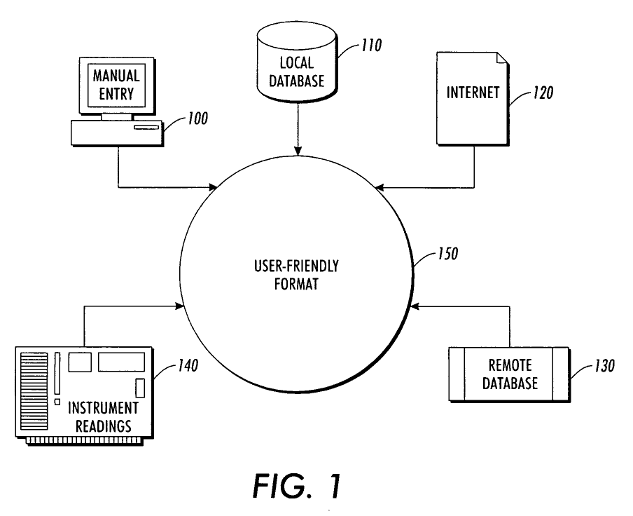

FIG. 1 illustrates various examples of different formats and different locations of data needed for decision-making. It is noted that FIG. 1 is not an exhaustive catalog of all possible formats and locations. As noted above, data is not necessarily in a computer-readable format, and thus, an operator may need to manually convert such data at a work station 100 in order to compile it into a usable format. Data may also be located on a local database 110. Such a local database 110 may require a specialized program to retrieve information from it.

Furthermore, the desired data to be gathered may be located on the Internet 120. If the desired data is located on the Internet 120, this desired data may need to be changed from its native format. The desired data may also be located on a remote database 130. Such a remote database may need a specialized program and a conventional data communication facility in order to extract information from it. This desired data may be gathered for answering a specific problem, but also may be gathered for mining purposes to enable the discovery of opportunities and risks.

Lastly, desired data may be gathered from instrument readings 140. Such instrument generated data may need to be numerically summarized or may need other transformation for use.

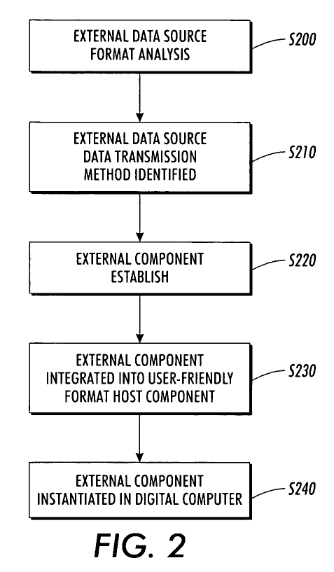

FIG. 2 illustrates a method whereby desired data from diverse sources, as illustrated in FIG. 1 or other sources not illustrated, may be collected and presented in a user-friendly format. Initially, at step S200, the format of the data source is analyzed. Thereafter, at step S210, a data transmission method for retrieving data from the data source is identified, if necessary.

At step S220, an external component is established, the external component being external to the host component used to display data in a user-friendly format. Although the example of the illustration of FIG. 2 demonstrates an external component, it is noted that the concepts of FIG. 2 are readily applicable to an internal component with respect to the host. The component or object is a computer-readable set of instructions that enable a digital computer to perform the task of retrieving information from the data source. The component or object may be established using conventional software development tools. It is noted that once the component or object is established, it can be re-used and distributed without any need for modification. This would save the cost of a repeated manual or partly manual step of data gathering each time the data is needed.

At step S230, as illustrated in FIG. 2, the component or object established in step S220 is integrated into a host component. A host component is a set of computer-readable instructions that enable a digital computer to present data to a decision-maker in a user-friendly format.

Lastly, at step S240, as illustrated in FIG. 2, the component or object is instantiate in a computer being used by the user. This may be accomplished when a user utilizes the host component in such a way that it will trigger the component or object to perform the action of retrieving data

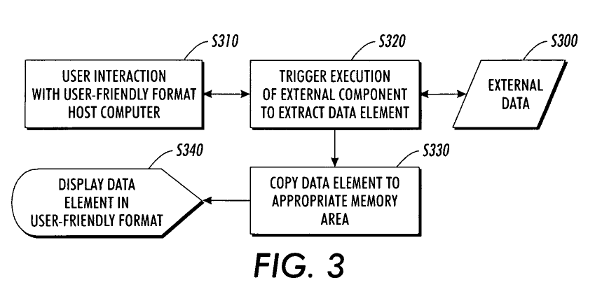

FIG. 3 illustrates, in more detail, the method of instantiating the component or object as discussed in step S240 above with respect to FIG. 2. Although the example of the illustration of FIG. 3 continues the external component of FIG. 2, it is noted that the concepts of FIG. 3 are readily applicable to an internal component with respect to the host. In step S310, the user utilizes the host component that presents information in a user-friendly format. This may take the form of entering a special string of text or of using a conventional pointing device to invoke the action of the component or object. Depending on how the component or object was integrated with the host component, there may be more action or less action or no action required by the decision-maker to invoke the action of the component or object.

At Step S320, the action of the component or object is triggered and a digital computer executes the instructions associated with the component or object that cause the external data 300 to be accessed. Depending on how the component or object was integrated with the host component, there may be various actions of the component or object that may be triggered. One such action may be making a particular element or a set of elements of the external data 300 available to the host component. Another possible action may be to generate a prompt or an error message for the user. Still another possible action may be to directly display, in a user-friendly manner, a particular element or a set of elements of the external data 300.

In the next step S330, the host component processes data made available by the component or object by copying one or more data elements extracted in step S320 from the external data 300 to the appropriate area of computer memory.

In the next step S340, the host component displays external data 300 processed in step S330 in a user-friendly format.

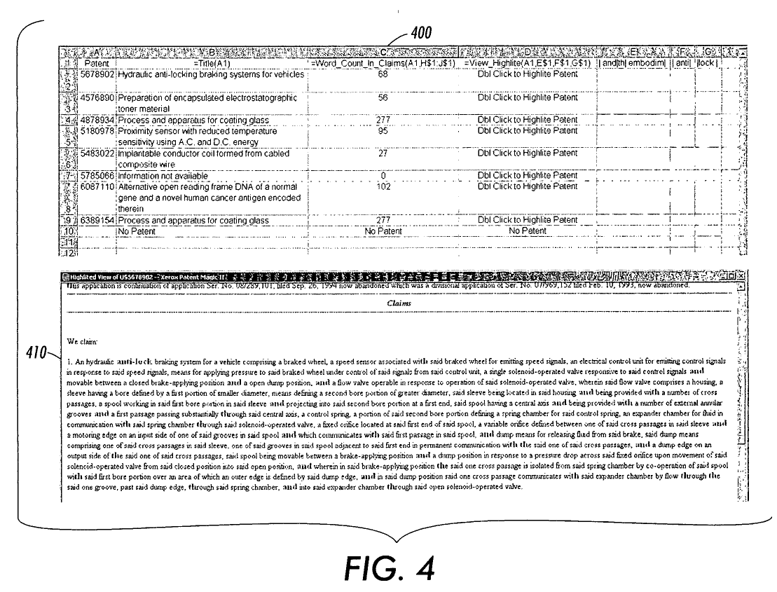

FIG. 4 illustrates a way in which the method for collecting data from diverse sources and transforming it into a user-friendly format.

In FIG. 4, a conventional electronic spreadsheet 400 is utilized as the user-friendly format for displaying the gathered desired data. As illustrated in FIG. 4, rows two through nine of column A show patent numbers. Rows two through nine of column B show the titles of those patents, each title corresponding to the patent number in column A of the same row. Rows two through nine of column C show the count of certain words found in the claims of those patents, each word count corresponding to the patent number in column A of the same row. Rows two through nine in column D show a prompt for the user of the spreadsheet.

As illustrated in FIG. 4, when a user activates any cell in column D, a new display window showing the claims of the patent in column A of the same row is shown with selected words highlighted 410. An example of this activation would be a user “double-clicking” an individual cell.

Lastly, as illustrated in FIG. 4, columns B through D of row 1 of the electronic spreadsheet display 400 show examples of special text strings that may be entered to invoke the action of the component or object. It is noted that the component may be internal or external to the host.

Relating the example of FIG. 4 to the method illustrated in FIG. 3, a patent number is entered in column A, row 2 (step S310 of FIG. 3). The user then enters the special text string “=Title(A2)” in column B, row 2. The entry of that text string invokes the action of the component or object integrated with the spreadsheet (step S320 of FIG. 3). The component or object accesses the external data 300 to retrieve the title of the patent, which patent number is in column A, row 2. The spreadsheet then copies that title information from the component or object into an appropriate area of memory (step S330 of FIG. 3). Finally, the spreadsheet displays the patent title in the same cell where the special text string was entered, replacing the visual display of the special text string with the patent title.

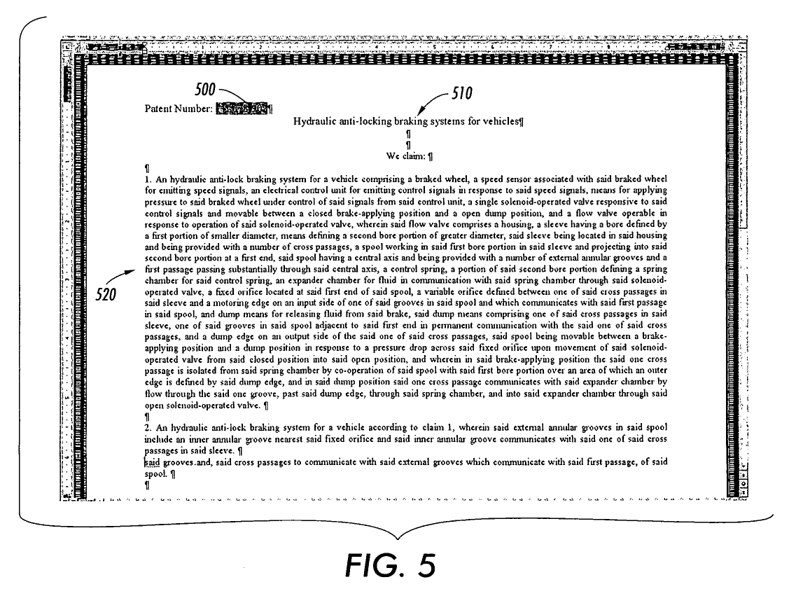

FIG. 5 illustrates another way in which the method for collecting data from diverse sources and transforming it into a user-friendly format to facilitate decision-making, herein described, may be utilized. In FIG. 5, a display similar to a conventional word processing display is shown. In the example, a patent number may be entered in the highlighted area 500. When that patent number is entered, it triggers the component or object to retrieve both the title 510 and the claims 520 of that patent and display them as text in the word processing display area as shown. It is noted that the component may be internal or external to the host.

Relating the example of FIG. 5 to the method illustrated in FIG. 3, a patent number is entered in the highlighted area (step S310 of FIG. 3). In this example, the entry invokes the component or object integrated with the host word processing component (step S320 of FIG. 3). The component or object accesses the external data 300 to retrieve the title and claims of the patent number that was entered in the highlighted area. The host word processing component then copies that information from the component or object into an appropriate area of memory (step S330 of FIG. 3). Finally, the host word processing component displays the patent title and claims in the display area of the host word processing component.

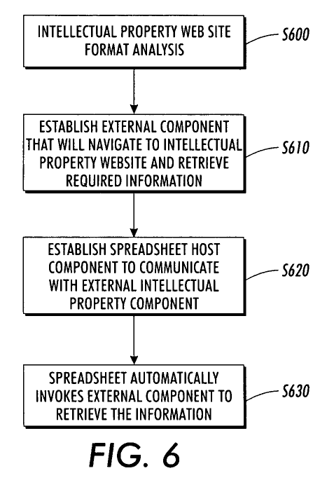

FIG. 6 further illustrates the method for collecting data from diverse sources and transforming it into a user-friendly format. For purposes of this example, a host spreadsheet component, similar to the one described in FIG. 4, is used. In step S600, a web site containing intellectual property information is identified and its format analyzed. In step S610, a component or object is set up that will perform the action of navigating to the intellectual property website and retrieving the required information. It is noted that the component may be internal or external to the host.

In step S620, the host spreadsheet component is set up to communicate with the component or object. For purposes of example, this may be accomplished using a conventional scripting language that may be supplied with a conventional electronic spreadsheet. A conventional scripting language can be used to create wrapper functions. The purpose of the wrapper function is to translate the interface requirements of the component or object into that required by the host component.

A wrapper function is one that can be invoked by name by the user of the spreadsheet. The name of a wrapper function along with any parameters established for it would constitute a special text string that would, when entered into the host component by a user, invoke the action of the component or object. It is noted that the details of creating such a wrapper function are known to those skilled in the art and will not be covered in more detail here.

In step S630, a user of the spreadsheet enters one of the special text strings set up as described above and this causes the component or object to acquire the requested data, as necessary, from local database, local cache of data, an external database or external cache of data, such as the internet.

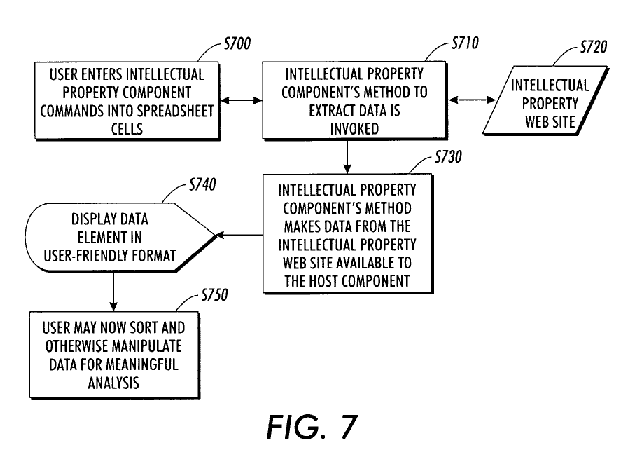

FIG. 7 illustrates, in more detail, the method of invoking the component or object as discussed in step S630 of FIG. 6. In step S700, the user utilizes the spreadsheet host component entering one of the special text strings set up as described above. At step S710, the component or object accesses the Internet and navigates to the website containing the specific intellectual property information requested by the user when the special text string was entered. Also, at step S710, the component or object makes the data from the intellectual property website available to the host spreadsheet component.

In step S730, the host component processes data made available by the component or object by copying one or more data elements made available in step S710 from the intellectual property website 720 to the appropriate area of computer memory.

In step S740, the host component displays external data in a user-friendly format. In step S750, the user now has the data from the intellectual property website in spreadsheet format which the user can view and/or manipulate in a manner consistent with conventional electronic spreadsheets.

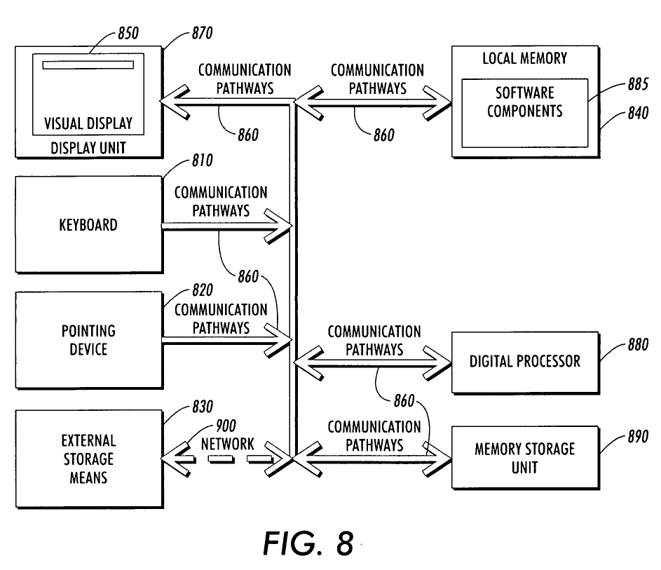

FIG. 8 shows a basic computer hardware configuration. It is noted that the method for collecting data from diverse sources and transforming it into a user-friendly format utilizes a digital computer. The user may utilize the digital processor 880 by entering commands via the keyboard 810 or by using a pointing device 820 to trigger specific actions to be performed by the digital processor 880. The information so entered by the user may be transmitted to the digital processor 880 by means of communication pathways 860. Within the local memory 840 of the digital processor 880 may be software components 885, which are sets of instructions for the processor that were loaded from a computer-readable data structure that may be located in the memory storage unit 890 or any other location accessible by either the communication pathways 860 or the network 900.

Data desired by the user may be located in either the local memory 840, the memory storage unit 890 local to the digital processor 880 or the external storage means 830. Data from all of these sources may be transmitted to and from the digital processor 880 by means of communication pathways 860. Further, data located in the external storage means 830, which is not local to the digital processor 880, may utilize a special part of the communication pathways 860 called a network 900.

The instructions in the software components 885, when executed, cause the digital processor 880 to retrieve data as discussed above and to transmit that data to the display unit 870 via the communication pathways 860. The display unit presents the data to the user in a visual display 850.

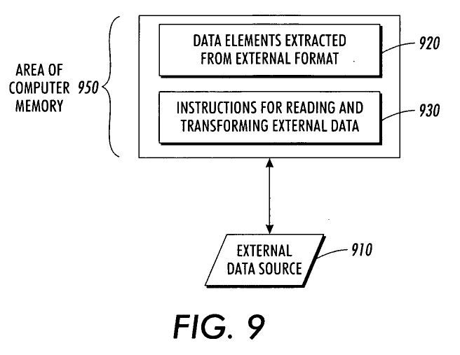

FIG. 9 illustrates the use of the component or object to parse an external data source. The component or object is loaded into an area of memory 950 in a digital computer. The instructions 930 for reading and transforming the data particular to the external data source 910, when executed, cause the digital computer to extract particular data elements 920 and copy them into part of the area of computer memory 950 allocated to the component or object.

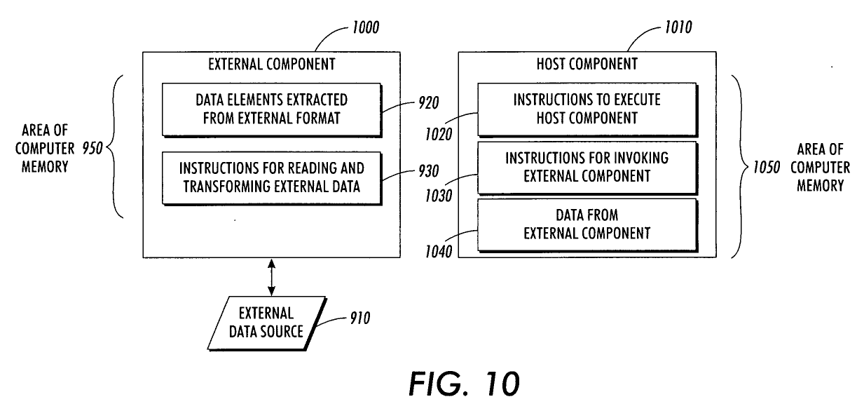

FIG. 10 illustrates the integration of the component or object with the host component. Both the component or object 1000 and the host component 1010 are loaded in the conventional manner into separate areas (950, 1050) of computer memory. The integration of the two components is accomplished by adding to the host component 1010, instructions 1030 for invoking the component or object 1000. A conventional scripting language or any other means that may so modify the host component may be used for this purpose. The instructions 1020 to execute the host component 1010 may now invoke the instructions 1030 for invoking the component or object 1000. The instructions 1030 for invoking the component or object 1000 may cause the instructions 930 for reading and transforming external data in the component or object 1000 to be executed. The component or object 1000 may then retrieve the external data 910 and make it available to the host component 1010. The host component may then store the data 1040 from the component or object and make it available to a user in a user-friendly format for viewing and/or manipulation.

It is noted that data from multiple diverse sources may be combined into one and the same display by using the method described herein. It is also noted that multiple component or objects 1000 may be integrated into one and the same host component 1010.

In summary, a method utilizes a computer-based system, for processing data gathered from diverse sources and diverse formats. The method determines the format of a data source; determines a communication protocol to retrieve data from the data source; uses the object, using the determined format and communication protocol, to retrieve data from the data source, the object acquiring information and transforming the information into a consistent format, the information being cached for repeated immediate or future use; integrates the object into an application residing on a host system; receives input from a user; instantiates, in accordance with the input from the user, the integrated object; and conveys data generated by the object to the user. The data generated by the object may be displayed, reproduced, and/or manipulated on a user readable medium. Moreover, the data generated by the object may be displayed, reproduced, and/or manipulated in a spreadsheet format. The method generates a wrapper function to invoke the object, the wrapper function including parameters that, when entered by a user, invoke the action of the component or object.

Furthermore, the method may determine the format of a web source data; determine a communication protocol to retrieve data from the web source; use the object, using the determined format and communication protocol, to retrieve data from the web-based data source, the object acquiring information and transforming the information into a consistent format, the information being cached for repeated immediate or future use; receive input from a user; instantiate, in accordance with the input from the user, the component or object; and convey data generated by the object to the user. The data generated by the object may be displayed, reproduced, and/or manipulated on a user readable medium. Moreover, the data generated by the object may be displayed, reproduced, and/or manipulated in a spreadsheet format. Also, the data generated by the object may be related to characteristics of intellectual property.

Lastly, a method, utilizing a computer-based system for processing patent data gathered from a web-based patent data source, by establishing an object, may determine the format of the web-based patent source data; determine a communication protocol to retrieve data from the web-based patent source; use the object, using the determined format and communication protocol, to retrieve data from the web-based patent source, the object acquiring information and transforming the information into a consistent format, the information being cached for repeated immediate or future use; receive input from a user; instantiate, in accordance with the input from the user, the integrated component or object; and convey data generated by the integrated object to the user. The data generated by the object may be displayed, reproduced, and/or manipulated on a user readable medium. Moreover, the data generated by the object may be displayed, reproduced, and/or manipulated in a spreadsheet format. Also, the data generated by the object may be related to characteristics of an issued patent or a published patent application.

It is noted that although the descriptions above have focused upon a computer based system, the methodology can also be carried out on any electronic device capable of processing data, such as, a personal computer, a laptop, a personal digital assistance, a personal communication device, etc.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, utilizing a computer-based system, of processing data gathered from diverse sources and diverse formats, by establishing an object, comprising:
(a) determining the format of a data source;
(b) determining a communication protocol to retrieve data from the data source;
(c) using the object, using the determined format and communication protocol, to retrieve data from the data source, the object acquiring information and transforming the information into a consistent format;
(d) receiving input from a user;
(e) instantiating, in accordance with the input from the user, the object; and
(f) conveying data generated by the object to the user.

2. The method as claimed in claim 1, wherein the data generated by the object is displayable.

3. The method as claimed in claim 1, wherein the data generated by the object is reproduced on a user readable medium.

4. The method as claimed in claim 3, wherein the data generated by the object is displayable in a spreadsheet format.

5. The method as claimed in claim 1, wherein the data generated by the object is able to be manipulated.

6. The method as claimed in claim 1, wherein the data generated by the object is cached.

7. The method as claimed in claim 1, further comprising:
(h) generating wrapper function to invoke the object, the wrapper function including parameters that, when entered by a user, invoke the action of the object.

8. A method, utilizing a computer-based system, of processing data gathered from a web data source, by establishing an object, comprising:
(a) determining the format of the web source data;
(b) determining a communication protocol to retrieve data from the web source;
(c) using the object, using the determined format and communication protocol, to retrieve data from the web data source, the object acquiring information and transforming the information into a consistent format;
(d) receiving input from a user;
(e) instantiating, in accordance with the input from the user, the object; and
(f) conveying data generated by the object to the user.

9. The method as claimed in claim 8, wherein the data generated by the object is displayable.

10. The method as claimed in claim 8, wherein the data generated by the object is displayable in a spreadsheet format.

11. The method as claimed in claim 8, wherein the data generated by the object is able to be manipulated.

12. The method as claimed in claim 8, wherein the data generated by the object is cached.

13. The method as claimed in claim 8, wherein the data generated by the object is related to characteristics of intellectual property.

14. A method, utilizing a computer-based system, of processing patent data gathered from a web-based patent data source, by establishing an object, comprising:
(a) determining the format of the web-based patent source data;
(b) determining a communication protocol to retrieve data from the web-based patent source;
(c) using the object, using the determined format and communication protocol, to retrieve data from the web-based patent source, the object acquiring information and transforming the information into a consistent format;
(d) receiving input from a user;
(e) instantiating, in accordance with the input from the user, the object; and
(f) conveying data generated by the object to the user.

15. The method as claimed in claim 14, wherein the data generated by the object is displayable.

16. The method as claimed in claim 14, wherein the data generated by the object is displayable in a spreadsheet format.

17. The method as claimed in claim 14, wherein the data generated by the object is able to be manipulated.

18. The method as claimed in claim 14, wherein the data generated by the object is related to characteristics of an issued patent.

19. The method as claimed in claim 14, wherein the data generated by the object is related to characteristics of a published patent application.

20. The method as claimed in claim 14, wherein the data generated by the object is cached.
